(19) United States
(12) Patent Application Publication
(10) Pub. No.: US 2007/0147819 A1
(43) Pub. Date: Jun. 28, 2007

(54) SYSTEM AND METHOD FOR INDICATING SHARPNESS OF IMAGES

(75) Inventors: CHIH-KUANG CHANG, Tu-Cheng (TW); Li Jiang, Shenzhen (CN); Zhong-Kui Yuan, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,711

(22) Filed: Sep. 15, 2006

(30) Foreign Application Priority Data
Dec. 27, 2005 (CN) 200510121381.X

(51) Int. Cl. G03B 13/30

(52) U.S. Cl. 396/147

(57) ABSTRACT

A system for indicating sharpness of images is provided. The system includes a computer, which is connected to a measuring machine for an object to be laid thereon for measurement. The measuring machine has a Z axis, on which a charged coupled device (CCD), an optical lens and a lever are installed. The computer includes: an image capturing card which connects the computer and the CCD for capturing a series of images from the CCD, transmitting the series of images to an image measuring module to calculate a sharpness value of each image; and an image focusing indicator for displaying sharpness of the series of images by a graph when a user operates the lever to focus the optical lens on the object. A related method is also provided.

### FIELD OF THE INVENTION

The present invention relates to systems and methods for image measuring, and more particularly, to a system and method for indicating sharpness of images during manual focusing of an object.

### DESCRIPTION OF RELATED ART

A charged coupled device (CCD) is an electrical device that is used to capture images of objects, store information (analogous to the way a computer stores information), or transfer electrical charge (as part of larger device). It receives as input, light from an object or an electrical charge. The CCD takes this optical or electronic input and converts it into an electronic signal—the output. The electronic signal is then processed by other equipment and/or software to either produce an image or to provide valuable information.

CCDs are used in a variety of different imaging devices, such as imagers or CCD cameras or scanners; CCDs are only part of the whole device. For capturing images of objects, an optical lens is required to properly focus the incident radiation from the object onto the array.

A conventional manual-focusing measuring machine generally includes a manual focusing apparatus for adjusting the optical lens to focus on the object, so as to obtain clear images of the object for measurement. Compared to an auto-focusing measuring machine, the manual-focusing measuring machine has its advantages of lower-cost and simpler structure. However, manual focusing relies on sight, different users may have different sharpness recognitions of the same image of the same object. As a result, different users may have to focus on the object repeatedly to obtain clear images for measurement, and the clear images of the same object used for measurement may be different to different users. Moreover, a sharpness degree of “the clear images” will directly affect the precision of the measurement of the object by a computer.

What is need, therefore, is a system and method for indicating sharpness of the images of the object during the manual focusing process, so as to assist manual focusing of the object, avoid different users to focus the object repeatedly, improve the focusing precision of the manual-focusing measuring machine.

### SUMMARY OF THE INVENTION

A system for indicating sharpness of images in accordance with a preferred embodiment is provide. The system includes a computer, which is connected to a measuring machine for an object to be laid thereon for measurement. The measuring machine has a Z axis, on which a charged coupled device (CCD), an optical lens and a lever are installed. The computer includes an image capturing card and an image focusing indicator. When a user operates the lever to focus the optical lens on the object, the image card, which connects the computer and the CCD, captures a series of images of the object from the CCD, transmits the series of images to an image measuring module in the computer to calculate a sharpness value of each image. The image focusing indicator is used for displaying sharpness of the series of images by a graph.

Another preferred embodiment provides a method for assisting manual focusing of images. The method includes the steps of: (a) setting display parameters of a graph showing sharpness of images of an object laid on a measuring machine; (b) moving a lever on a Z axis of the measuring machine within a focusing area; (c) capturing a series of images of the object by a charged coupled device (CCD) installed on the Z axis of the measuring machine during the movement of the lever; (d) computing a sharpness value of each image; (e) drawing the graph to show the sharpness of the series of images according to the display parameters and the sharpness value of each image; and (f) displaying the graph on a screen of the computer.

Other advantages and novel features of the embodiments will be drawn from the following detailed description with reference to the attached drawings.

### BRIEF DESCRIPTION OF THE DRAWINGS

FIG. 1 is a schematic diagram of hardware configuration of a system for indicating sharpness of images according to a preferred embodiment;

FIG. 2 is a schematic diagram of main function modules of an image focusing indicator in FIG. 1;

FIG. 3 is a flowchart of a preferred method for indicating sharpness of images; and

FIG. 4 is an example of a sharpness curve for indicating sharpness of images.

### DETAILED DESCRIPTION OF THE INVENTION

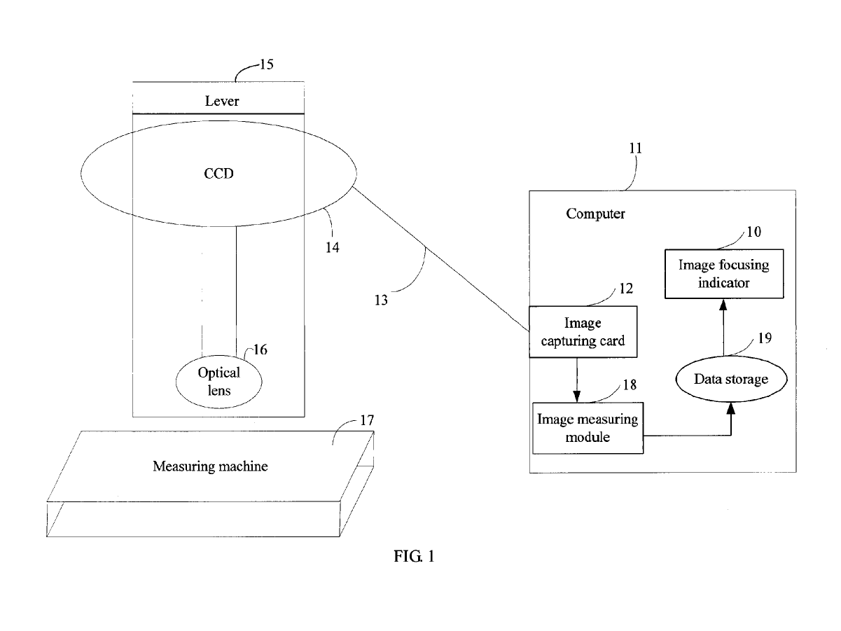

FIG. 1 is a schematic diagram of hardware configuration of a system for indicating sharpness of images. The system includes a computer 11 and a measuring machine 17 for an object to be laid thereon for measurement. A charged coupled device 14 (hereinafter, “the CCD 14”) is installed on a Z axis of the measuring machine 17. The CCD 14 is used for capturing a series of images of the object located on the measuring machine 17 via an optical lens 16 that is installed in front of the CCD 14. Furthermore, a lever 15 is installed on the Z axis of the measuring machine 17 for focusing the optical lens 16 on the object manually. The computer 111 includes an image capturing card 12, an image focusing indicator 10, an image measuring module 18, and a data storage 19. The CCD 14 is connected with the image capturing card 12 via a data bus 13. When the lever 15 is operated to focus the optical lens 16 on the object, the CCD 14 transmits electrical signals of the series of images of the object to the image capturing card 12 through the data bus 13. The image measuring module 18 is used for computing a sharpness value of each image in the series of images. The image focusing indicator 10 is used for showing sharpness of each image in the series of images with a graph. The data storage 19 is used for storing sharpness values of each image in the series of images computed by the image measuring module 18.

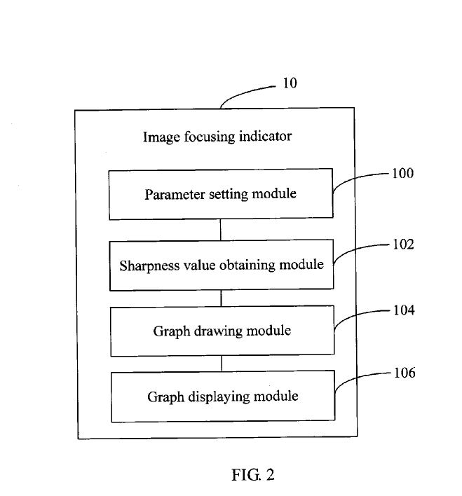

FIG. 2 is a schematic diagram of main function modules of the image focusing indicator 10. The image focusing indicator 10 includes a parameter setting module 100, a sharpness value obtaining module 102, a graph drawing module 104, and a graph displaying module 106.

The parameter setting module 100 is used for setting display parameters of the graph indicating sharpness of each image in the series of images of the object. The display parameters typically include: a unit length of an X axis and a unit length of a Y axis of a two-dimensional coordinates of the graph, a background color of the graph, and the color of the graph.

The sharpness value obtaining module 102 is used for obtaining a sharpness value of each image in the series of images computed by the image measuring module 18. The graph drawing module 104 is used for drawing the graph to reflect the sharpness of each image in the series of images according to the display parameters and the sharpness value of each image. The graph displaying module 106 is used for displaying the graph on a screen (not shown) of the computer 11 showing the sharpness of each image in the series of images of the object.

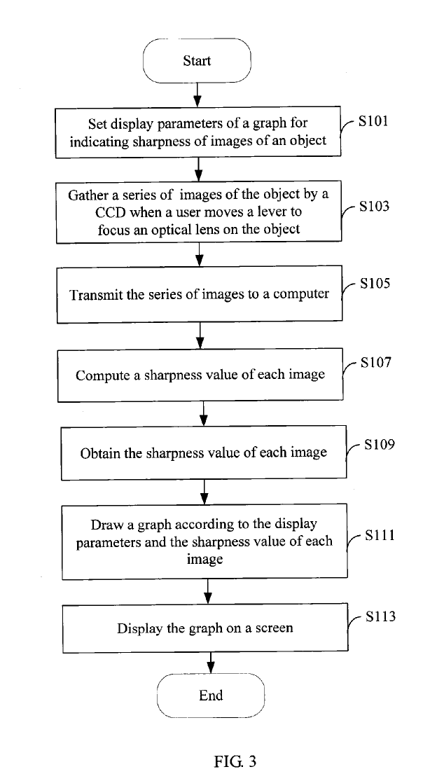

FIG. 3 is a flow chart of a preferred method for indicating sharpness of images. Firstly, an object is laid on the measuring machine 17. Then, in step S101, the parameter setting module 100 sets display parameters of the graph in order to reflect sharpness of each image in a series of images of the object captured by the CCD 14 via the optical lens 16. The display parameters include: a unit length of an X axis and a unit length of a Y axis of a two-dimensional coordinates in the graph, a background color of the graph, and the color of the graph. In this embodiment, the graph is a sharpness curve.

In step S103, the lever 15 is moved along the Z axis within a focusing area in order to focus the optical lens 16 on the object, the CCD 14 captures the series of images of the object. In step S105, the image capturing card 12 obtains the series of images from the CCD 14 through the data bus 13, and transmits the series of images to the image measuring module 18. In step S107, the image measuring module 18 computes the sharpness value of each image in the series of images, and stores the sharpness value in the data storage 19. In step S109, the sharpness value obtaining module 102 obtains the sharpness value of each image in the series of images from the data storage 19. In step 111, the graph drawing module 104 draws the sharpness curve according to the display parameters and the sharpness value of each image in the series of images of the object. In step S113, the graph displaying module 106 displays the sharpness curve on the screen of the computer 11 reflecting the sharpness of each image in the series of images.

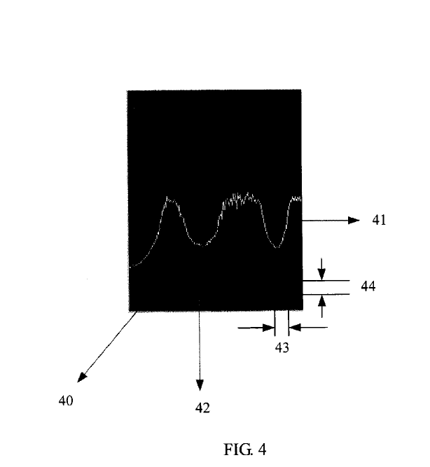

FIG. 4 an example of a sharpness curve for indicating sharpness of images. The background color of the graph is black, and the color of the sharpness curve is white. The unit length of the X axis and the Y axis of the coordinates in which the sharpness curve is located are both 1 mm. When the lever 15 is moved along a direction to focus the optical lens 16 on the object, the CCD 14 captures the series of images of the object. At the beginning, the images are blurry, which can be seen that in the sharpness curve in FIG. 4 is at low locations in the first stage. When the lever 15 continues moving along the same direction, the sharpness curve is in an ascending trend, indicating that the images in the series of images are clearer and sharper. When the sharpness curve is a wave crest, the image in the series of images of the object captured by the CCD 14 is the clearest and sharpest. Continuing to move the lever 15 along the same direction causes the image of the object to become out of focus, the images become slowly blurs, and the sharpness curve is in a descending trend. Moving the lever 15 in this mode repeatedly, the sharpness curve reaches wave crests and troughs periodically. When the sharpness curve forms a wave crest, the image of the object is clearest. Therefore, the user can adjust a foci of the optical lens 16 to focus the object based on the sharpness curve.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for indicating sharpness of images comprising a computer, the computer being connected to a measuring machine which has a Z axis, the Z axis being installed with a charged coupled device (CCD), an optical lens and a lever, the computer comprising:
an image capturing card for connecting the computer with the CCD, and capturing a series of images of an object laid on the measuring machine from the CCD when a user operates the lever to focus the optical lens on the object;
an image measuring module for calculating a sharpness value of each image of the series of images; and
an image focusing indicator for displaying sharpness of the series of images by a graph.

2. The system as claimed in claim 1, wherein the image focusing indicator comprises:
a parameter setting module for setting display parameters of the graph;
a sharpness value obtaining module for obtaining a sharpness value of each image;
a graph drawing module for drawing the graph to reflect the sharpness of the series of images; and
a graph displaying module for displaying the graph on a screen of the computer to show the sharpness of the series of images of the object.

3. The system as claimed in claim 2, wherein the display parameters comprise:
a unit length of an X axis and a unit length of a Y axis of a two-dimensional coordinates in which the graph is located, a background color of the graph and a color of the graph.

4. The system as claimed in claim 1, wherein the graph is a sharpness curve.

5. A computer-based method for indicating sharpness of images, comprising the steps of:
setting display parameters of a graph showing sharpness of images of an object laid on a measuring machine;
moving a lever on a Z axis of the measuring machine within a focusing area;
capturing a series of images of the object by a charged coupled device (CCD) installed on the Z axis of the measuring machine during the movement of the lever;
computing a sharpness value of each image;
drawing the graph to show the sharpness of the series of images according to the display parameters and the sharpness value of each image; and
displaying the graph on a screen of the computer.

6. The method as claimed in claim 6, wherein the graph is a sharpness curve.

7. The method as claimed in claim 6, wherein the display parameters of the graph comprise: a unit length of an X axis and a unit length of a Y axis of a two-dimensional coordinates in which the sharpness curve is located, a background color of the sharpness curve and a color of the sharpness curve.
